(19) United States
(12) Patent Application Publication
(10) Pub. No.: US 2013/0015218 A1
(43) Pub. Date: Jan. 17, 2013

(54) Apparatus for Connecting a Carrier to a Hardtop

(71) Applicant: Uri Surkin, Los Angeles, CA (US)

(72) Inventor: Uri Surkin, Los Angeles, CA (US)

(21) Appl. No.: 13/183,698

(22) Filed: Jul. 15, 2011

(51) Int. Cl. B60R 9/04

(52) U.S. Cl. 224/309

(57) ABSTRACT

The apparatus attaches a carrier to a vehicle hardtop. The bottom edges of the hardtop sidewalls. The apparatus includes a support plate that conforms to the structure at the intersection of the hardtop's top and sidewall. A locking bar extends from a flange associated with the support plate, and a hook at the bottom of the locking bar engages the bottom the hardtop's sidewall. A screw attached to the locking bar can tighten the hook against the bottom of the sidewall and urge the bracket against the hardtop to secure the carrier to the hardtop.

### NOTICE OF COPYRIGHTS AND TRADE DRESS

A portion of the disclosure of this patent document contains material that is subject to copyright protection. This patent document may show or describe matter that is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

Mounts for vehicle rooftop carriers.

2. Background and State of the Art

Mounting a carrier on top of a vehicle allows users of vehicles to carry extra luggage, a cooler, boxes, camping equipment and other items with them. The carriers are especially useful for camping, long-distance travel or airport trips where a vehicle has insufficient trunk space for carrying luggage or other items. Trunk space is noticeably limited on subcompact and sports cars and off-road vehicles.

Vehicle roofs normally are good platforms for mounting a carrier. Gonzalez, Publ. Appl. US2006/0237501 is an example of a rooftop carrier. It uses J-shaped hooks on straps depending from the carrier. The hooks attach to ledges above the vehicle windows. However, many vehicles do not have a complete roof covering the entire vehicle. For example, the Jeep® Wrangler and similar vehicles have open rear ends, and many have large roof openings. Owners of the vehicles may cover the backend or roof openings with a soft top especially during bad weather, but the sportiness of these types of vehicles allows the driver to keep everything open.

Vehicle owners can replace soft tops or backend covers with a hardtop. Many aftermarket manufacturers offers hardtop specifically designed for particular vehicles. The beds of pickup trucks also are open, and many owners enclose the bed with a removeably hardtop. The owners may install the hardtop when they shop or go camping because the hardtop can protect items stored on the truck bed.

However, attaching carriers to hardtops may create problems. Most carriers attach to a hardtop with bolts extending through the fiberglass or other hardtop material. This is disadvantageous because rainwater can leak through the holes in the hardtop. Removing the carrier from the hardtop, allows the holes to become points of entry for dirt, insects or rodents. The holes can be plugged, but they still can leak, and any plugs can be misplaced. In addition, when the vehicle is sold or traded in with the hardtop, the holes in the hardtop may affect the price adversely.

### BRIEF DESCRIPTION OF THE DRAWINGS

FIG. 1 is a perspective view of a vehicle with a hardtop and a carrier mounting on the hardtop.

FIGS. 2, 3 and 4 are detailed perspective view of regions 1, 2 and 3 in FIG. 1.

FIG. 5 is a sectional view through plane 5-5 in FIG. 1.

When detailed descriptions reference one or more drawing figures, the element being discussed is visible in that drawing. The element also may be visible in other figures. In addition, to avoid crowding of reference numerals, one drawing may not use a particular reference numeral where the same element is in another drawing with the reference numeral.

### SUMMARY

The apparatus attaches a carrier to a vehicle hardtop. The hardtop has a top wall and sidewalls depending from the top wall. The sidewalls have bottom edges that are in contact with the rear portion of the vehicle. An angled or curved intermediate region is between the top wall and the sidewalls. The bracket that attaches a carrier to the hardtop includes an upper bracket that has a first bracket segment for attaching to the carrier. A second segment of the bracket is supported by the intermediate region of the hardtop and conforming to the intermediate region's shape. The bracket also has a depending segment extending along the hardtop's sidewall to its bottom edge. A hook on the depending segment is positioned near the bottom edge of the hardtop and secures the bracket to the edges.

### DETAILED DESCRIPTION

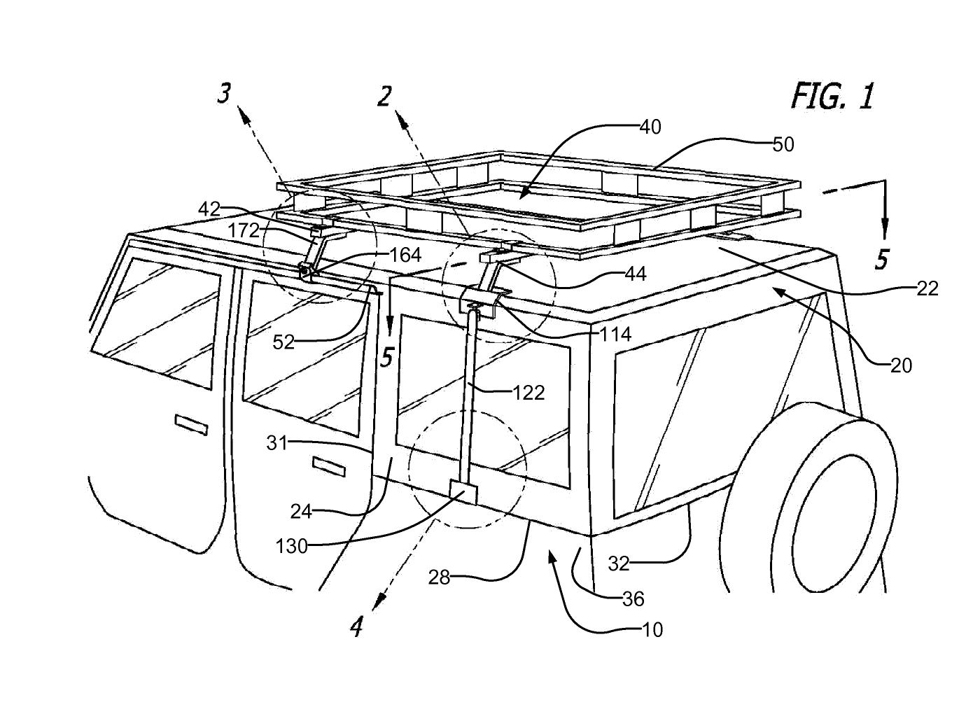

The apparatus connects a carrier to a hardtop. A hardtop is a vehicle accessory that covers the top, sides and rear of part of vehicles. In FIG. 1, vehicle 10 is a sporty vehicle such as a Jeep Wrangler. The vehicle shown has four doors, but two-door vehicles have similar designs.

The upper, rear end of the vehicle is open, and the top may have openings (not shown) too. A removable soft top (not shown) of canvas or other material may cover the open rear. Covers of similar material may be used to cover the roof openings. One can use a hardtop cover the rear and the openings in the roof. Hardtops are usually made of fiberglass or similar material.

Hardtop 20 has a generally flat top portion 22 and depending sidewalls 24 and 26 (FIGS. 1 and 3). The top may extend to the front of the vehicle to cover other vehicle roof openings. Fasteners or other connectors on the hardtop or vehicle secure them together. As FIG. 1 shows, front edge 30 of hardtop sidewall 24 engages the driver-side (left-hand drive) rear pillar. Bottom edge 28 of sidewall 24 rests on the top of side of the driver-side rear panel 36, and bottom edge 32 of rear wall 20 is on the rear wall or rear door of the vehicle.

Carrier 40 is designed to fit above top 22 of hardtop 20. The carrier shown in FIGS. 1 and 3 includes an open rack 50, which is open on top so that one can position luggage, camping gear, tools, coolers or other items in the carrier. One could attach ropes, shock cords, a tarp or other securing devices to the carrier and the items to hold the items. The carrier also could support a bicycle rack. An enclosed shell could be used instead of an open rack.

Carrier 40 includes spaced-apart transverse supporting braces 42 and 44 (FIGS. 1 and 3) that may support the open rack 50 or other structure. Some will use only the supporting braces as the carrier. The braces are well suited for carrying long flat objects such as plywood. ladders or boxes for ready-to-assemble furniture.

Similar carriers have been attached to hardtops by bolting the carriers through drilled holes the hardtop. Instead of bolting, carrier 40 attaches to the hardtop as follows.

Top portion 22 of hardtop 20 intersects sidewalls 24 and 26 at intermediate regions or short, angled sections 32 and 34 respectively. This shape may be particular to a specific hardtop because each hardtop manufacturer might design the angled sections differently. The angles sections also may be vary for different vehicles. Moreover, instead of angled sections, the hardtop's top and sidewalls may have curved interfaces or they may meet without angled or curved sections.

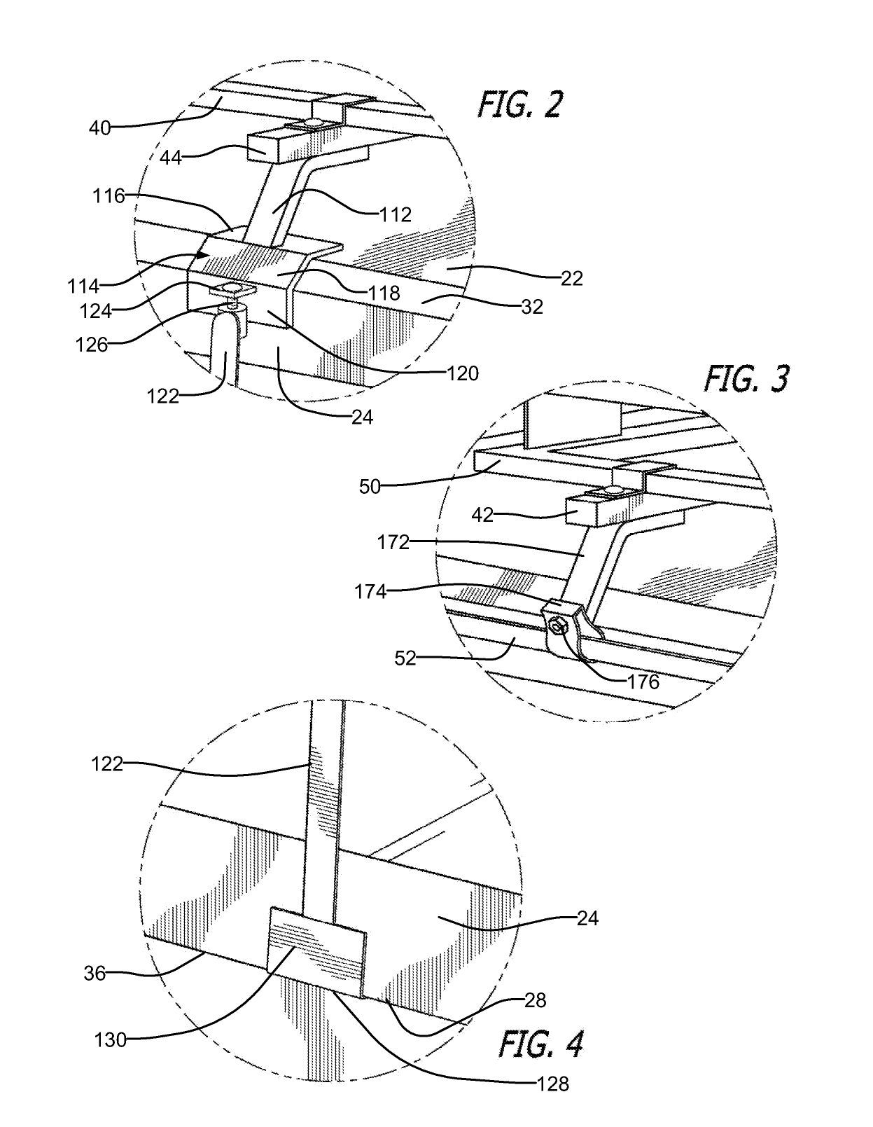

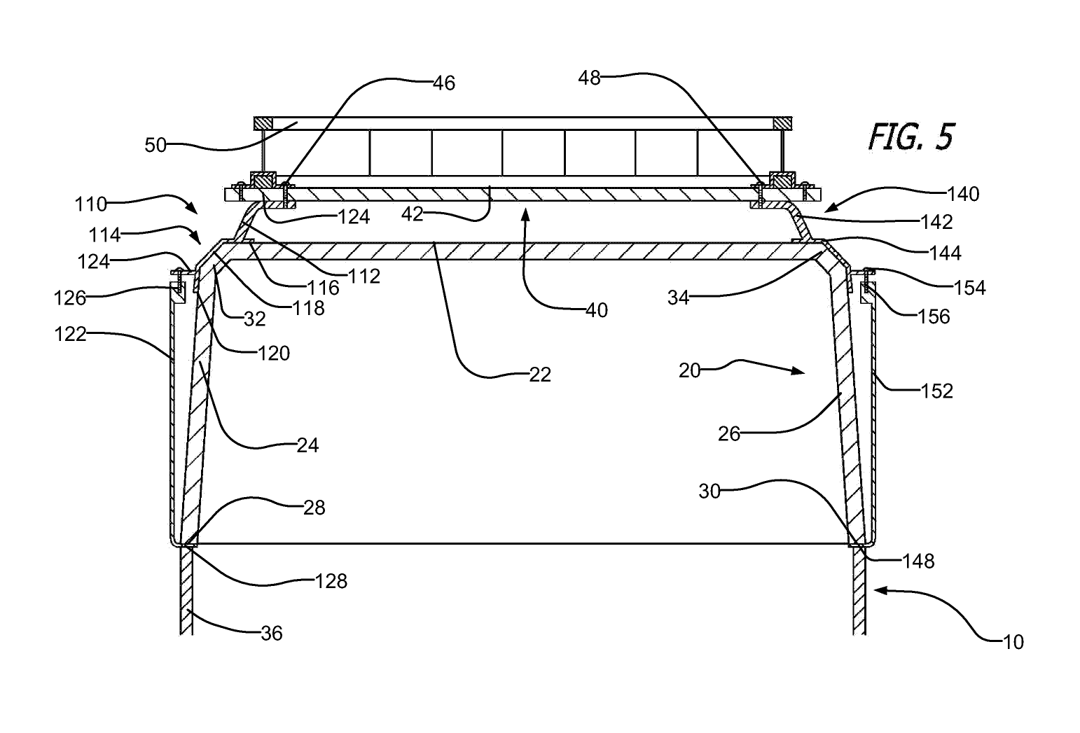

Brackets 110 and 140 on the sides of rear transverse brace 44 support the rear end of carrier 40 (FIGS. 1, 2 and 5). Similar brackets such as bracket 172 (FIGS. 1 and 3) on front transverse brace 42 support the front end of the carrier. Bracket 110 may include an L-shaped strut 112. Bolts or other fasteners 46 may attach the top of the strut to the carrier's rear transverse brace 44 (FIGS. 2 and 5). The lower portion of the strut attaches to support plate 114. The strut and support plate may be a single part made by casting or other process. They also may be welded or otherwise attached together. The strut's lower part may be of two parts that slide relative to each other to adjust the length of its lower part.

Plate 114 may conform to the shape of the side of the hard top. That is, with hardtop 20 (FIG. 5), the plate may include a generally horizontal portion 116 that lies along the top surface 22 of the hard top. Angled section 118 lies along angled section 32, and the lower section 120 lies against the sidewall 24. If the intersection of the sidewalls to the top of the hardtop is curved, plate 114 could be shaped to conform to the curved shape. Likewise, if the intersection of the sidewall and top wall has no angled section, plate 114 would not require an angled section. The dimensions of plates 114 and 144 should be sufficient to spread out the load from carrier 40 on hardtop 20.

Bracket 110 may include flange 124 extending outward from lower section 120 of plate 114 (FIGS. 2 and 5). The flange holds adjusting screw 126, and locking bar 122 depends from the screw and flange. The locking bar may be metal or other material that has sufficient tensile strength to avoid breaking under the applied tension. The bottom of the locking bar has a hook 128 that engages bottom edge 28 of sidewall 24 between the bottom edge and the top of driver-side rear panel 36. FIG. 5 shows the hook with a bottom perpendicular to bar locking, but the two parts could have a different angle. Further, the hook could have another portion extending upward from the hook's right side (FIG. 5) to make it more J-shaped.

Hook 128 at the bottom of locking bar 122 may be wider at 130 than the rest of the locking bar. Just as plates 114 and 144 are wide to spread the load on the top of hardtop 20, the wider hook spreads the load on the bottom edge of sidewall 26.

After placing plate 114 properly along the top of sidewall 24 (FIG. 5), hook 128 is inserted between the top of driver-side rear panel 36 and bottom 28 of the sidewall. Adjusting screw 126 is tightened to urge the hook and plate toward each other to secure the parts together. To remove plate 114 and the carrier from the vehicle, adjusting screw 126 is loosened until hook 128 can be removed from under the bottom of the sidewall. Instead of using adjusting screws, one could use other devices such as an over-center buckle for shortening the distance of the hook to the support plates.

The attachment of the passenger side of rear transverse brace 44 is similar to the attachment of the driver side of the rear transverse brace. Not every part on the passenger side that serves a similar function to the driver-side part is discussed. Bracket 140 (FIG. 5) includes L-shaped strut 142. Bolt 48 attaches the bracket to rear transverse brace 44. The lower portion of the strut attaches to support plate 144, which conforms to the hard top. See FIG. 5. Adjusting screw 156 extends through flange 154 and engages locking bar 152. The bottom of the locking bar engages the bottom 30 of sidewall 26. Tightening the adjusting screw urges the hook and support plate together to secure the carrier 40 to the hardtop.

Front transverse brace 42 of carrier 40 may attach to the vehicle differently from the attachment of rear transverse brace 44. The upper part of L-shaped strut 142 attaches to the transverse brace as FIGS. 1 and 3 show. The lower part of the L-shaped strut attaches to clamp 174. The lower part of the strut may be of two parts that slide relative to each other so that the length of the strut's lower part can be adjusted. The clamp's open bottom fits over rain guard 52 or other part close to the top of the vehicle. Tightening bolt 176 urges the jaws of the clamp together to secure the clamp to the rain guard.

Thus, with brackets 110 and 140 securing the rear of carrier 40 to hardtop 20 and bracket 172 and another similar bracket on the vehicle's passenger side securing the front of the carrier to the hardtop, the carrier is secured to the hardtop without requiring mounting holes in the hardtop.

The description is illustrative and not limiting and is by way of example only. Although this application shows and describes examples, those having ordinary skill in the art will find it apparent that changes, modifications or alterations may be made. Many of the examples involve specific combinations of method acts or system elements, but those acts and those elements may be combined in other ways to accomplish the same objectives. With regard to flowcharts, additional and fewer steps may be taken, and the steps as shown may be combined or further refined to achieve the methods described. Acts, elements and features discussed only in connection with one embodiment are not intended to be excluded from a similar role in other embodiments.

“Plurality” means two or more. A “set” of items may include one or more of such items. The terms “comprising,” “including,” “carrying,” “having,” “containing,” “involving,” and the like in the written description or the claims are open-ended, i.e., each means, “including but not limited to.” Only the transitional phrases “consisting of” and “consisting essentially of” are closed or semi-closed transitional phrases with respect to claims. The ordinal terms such as “first,” “second,” “third,” etc., in the claims to modify a claim element do not by themselves connote any priority, precedence, or order of one claim element over another or the temporal order in which acts of a method are performed. Instead, they are used merely as labels to distinguish one claim element having a certain name from another element having a same name (but for use of the ordinal term). Alternatives such as “or” include any combination of the listed items.

1. (canceled)

2. (canceled)

3. (canceled)

4. (canceled)

5. (canceled)

6. (canceled)

7. (canceled)

8. (canceled)

9. A carrier for a vehicle wherein the vehicle has an attached hardtop, the vehicle having a top, wherein the hardtop has a top wall, sidewalls intersecting and depending from the top wall, the top wall and sidewalls forming hardtop edges at the intersection of the top wall and sidewalls, the hardtop including a bottom edge attachable to a vehicle and intermediate regions between the edges of the top wall and the sidewalls, the carrier comprising:
a generally horizontal, planer surface above the top of the vehicle and above the top of the hardtop
a first and second brace below the horizontal, planer surface, each brace having an end;
a first and second bracket attached to the first brace and each comprising a first bracket segment attachable to the carrier, a second bracket segment, each second bracket segment adapted to engage a hardtop edge, first and second bracket further comprising a depending bracket segment extending to the bottom edge of the hardtop;
a hook attached to each depending bracket segment and adapted to engage the bottom edge of the hardtop;
a third and fourth bracket attached to the second brace and each third and fourth bracket comprising a second bracket segment adapted to attach to the vehicle.

10. The apparatus of claim 9 wherein the third and fourth brackets are adapted to be out of contact with the top of the vehicle.

11. The apparatus of claim 9 wherein the spacing between the bracket and hook is adjustable.

12. The apparatus of claim 9 further comprising an adjustment mechanism between the depending bracket segment and the and at least one of the first and second bracket segments for moving the at least one depending bracket segment toward and away from the at least one of the first and second bracket segments.

13. The apparatus of claim 9 further comprising means associated with the depending bracket segment to adjust spacing between the depending bracket segment and at least one of the first and second bracket segments.

14. A combined vehicle, hardtop and carrier wherein the vehicle comprises a top above other parts of the vehicle, the hardtop attached to the vehicle and the carrier attached to the vehicle and hardtop, and wherein the hardtop has a top wall above other parts of the hardtop and sidewalls depending from the top wall of the hardtop, the intersection of the side walls and the top wall of the hardtop comprising hardtop edges, the hardtop comprising a bottom edge attachable to a vehicle, the bottom edge of the hardtop being lower than the top of the vehicle, wherein the carrier comprising:
a generally horizontal, planer surface above the top of the vehicle and above the top of the hardtop
a first and second brace between the horizontal, planer surface and the top of the hardtop, each brace having two ends;
a first bracket near one end of the first brace and a second bracket near the other end of the first brace, each bracket comprising a first bracket segment attachable to the carrier, a second bracket segment adapted to conform to one of the hardtop edges and a depending bracket segment extending to the bottom edge of the hardtop;
a hook attached to the depending segment and adapted to engage the bottom edge of the hardtop, wherein the depending segment is adapted to position the hook adjacent the bottom edge of the hardtop;
a third bracket attached adjacent to one end the second brace and fourth bracket attached adjacent to the other end the second brace, each bracket comprising a third bracket segment attachable to the vehicle.

15. The apparatus of claim 14 wherein the third and fourth brackets are adapted to be out of contact with the top of the vehicle.

16. The apparatus of claim 14 wherein the spacing between the bracket and hook is adjustable.

17. The apparatus of claim 14 further comprising an adjustment mechanism between the depending bracket segment and the at least one of the first and second bracket segments for moving the at least one depending bracket segment toward and away from the at least one of the first and second bracket segments.

18. The apparatus of claim 14 further comprising means associated with the depending bracket segment to adjust spacing between the depending bracket segment and at least one of the first and second bracket segments.

19. A carrier attachable to a vehicle comprising a generally horizontal, planer surface; first and second braces under the horizontal, planer surface, each brace having ends; a first bracket attached to one end of the first brace and a second bracket attached to the other end of the first brace; a clamp attached each of the first and second braces, the clamps adapted to grip a portion of the vehicle; a third bracket attached to one end of the second brace and a fourth bracket attached to the other end of the second brace; a first depending bracket segment having an upper end attached to and depending from the third bracket and a second depending bracket segment having an upper end attached to and depending from the fourth bracket, each depending bracket segment having a lower end substantially below the clamps; and a hook attached to the lower end of each depending bracket segment.

20. The apparatus of claim 19 wherein the third and fourth brackets are adapted to be out of contact with the top of the vehicle.

21. The apparatus of claim 19 wherein the spacing between the third and fourth bracket and hook of each depending bracket segment is adjustable.

22. The apparatus of claim 19 further comprising an adjustment mechanism between the depending bracket segment and the at least one of the first and second bracket segments for moving the at least one depending bracket segment toward and away from the at least one of the first and second bracket segments.

23. The apparatus of claim 19 further comprising means associated with at least on depending bracket segment to adjust spacing between the depending bracket segment and at least one of the first and second bracket segments.
